(19) United States
(12) Patent Application Publication
(10) Pub. No.: US 2026/0010046 A1
(43) Pub. Date: Jan. 8, 2026

(54) ELECTROCHROMIC ELEMENT AND DEVICES INCLUDING THE SAME

(71) Applicant: CANON KABUSHIKI KAISHA, Tokyo (JP)

(72) Inventor: KAZUYA MIYAZAKI, Tokyo (JP)

(21) Appl. No.: 19/325,295

(22) Filed: Sep. 10, 2025

Related U.S. Application Data
(63) Continuation of application No. PCT/JP2024/009261, filed on Mar. 11, 2024.

(30) Foreign Application Priority Data
Mar. 29, 2023 (JP) 2023-053344

(51) Int. Cl. G02F 1/153; G02F 1/155

(52) U.S. Cl. CPC G02F 1/1533; G02F 1/155

(57) ABSTRACT

An EC element includes a separator that divides the gap between electrodes into two sections, and a pair of EC layers with the separator therebetween. The separator has an ionic resistance of 50 Ωcm² to 300 Ωcm² in the thickness direction thereof when impregnated with 0.1 M tetrabutylammonium TFSI/propylene carbonate solution.

### CROSS-REFERENCE TO RELATED APPLICATIONS

This application is a Continuation of International Patent Application No. PCT/JP2024/009261, filed Mar. 11, 2024, which claims the benefit of Japanese Patent Application No. 2023-053344, filed Mar. 29, 2023, both of which are hereby incorporated by reference herein in their entirety.

### BACKGROUND

### Field of the Technology

The present disclosure relates to an electrochromic element and devices including the electrochromic element.

### Description of the Related Art

An electrochromic (hereinafter also abbreviated to EC) element is an active optical element that includes a pair of electrodes and an EC layer between the electrodes. The EC element adjusts the hue or amount of light in the visible light region by applying a voltage between the pair of electrodes to oxidize or reduce a compound in the EC layer.

The application of EC elements has gradually expanded as dimming windows for homes and aircraft, and in recent years, there has been a growing demand for environmental considerations. Accordingly, a dimming window that achieves a larger area and lower power consumption while maintaining performance is demanded.

EC elements using organic EC compounds, first of all, have a wide range of adjustment in the amount of light and are relatively easy to design in color. In addition, it is preferable in view of the coloring efficiency (amount obtained by dividing the change in optical density by required charge) to complementary contain an electrochemically active anodic material and an electrochemically active cathodic material between the pair of electrodes, both of which have EC properties. In order to achieve a rapid response, larger amounts of organic EC compounds are required to react per unit time at the surface of the electrodes. For this purpose, the EC layer is preferably in the form of a solution or gel, which allows organic EC compounds to move freely within the EC layer. In such a form, however, the anodic and cathodic organic EC compounds that have reacted between the pair of electrodes undergo charge exchange (side reaction) within the EC layer and relax their electrochemical behavior to neutral states. Therefore, continuous energization is required to maintain the optical density. This hinders reduced power consumption of EC elements.

U.S. Pat. No. 3,453,038 discloses a structure for complementary EC elements that is provided with a permselective film that allows electrolyte ions to pass through but not reaction molecules in the EC layer to avoid side reactions between reaction products produced at the pair of electrodes.

Also, U.S. Pat. No. 10,996,536 discloses a structure for complementary EC elements that uses a permselective film achieving a light transmittance of 80% or more to avoid side reactions between reaction products produced at the pair of electrodes.

However, these known techniques do not clarify the requirement for the permselective film that divides the EC layer into two sections, namely, the requirements for transparency, and the requirement for preventing side reactions to achieve lower power consumption. In addition, U.S. Pat. No. 10,996,536 does not achieve sufficiently low power consumption.

### SUMMARY

Accordingly, the present disclosure provides a complementary organic EC element that avoids side reactions between reaction products produced at a pair of electrodes, has a memory effect, achieves low power consumption, and further exhibits excellent transparency in its neutral state.

An electrochromic element includes a first electrode, a second electrode, a separator that divides a gap between the first electrode and the second electrode into two sections, a first electrochromic layer disposed between the first electrode and the separator and containing at least one cathodic electrochromic compound, and a second electrochromic layer disposed between the second electrode and the separator and containing at least one anodic electrochromic compound. The separator has an ionic resistance of 50 Ωcm² to 300 Ωcm² in the thickness direction thereof when impregnated with 0.1 M tetrabutylammonium bis(trifluoromethanesulfonyl)imide/propylene carbonate solution.

Features of the present disclosure will become apparent from the following description of embodiments with reference to the attached drawings.

### BRIEF DESCRIPTION OF THE DRAWINGS

FIG. 1 is a schematic sectional view of an EC element according to an embodiment of the present disclosure.

FIG. 2 is a schematic diagram of a drive unit including an EC element of the present disclosure.

FIG. 3A is a schematic diagram of an imaging device in which an optical filter is disposed in a lens unit.

FIG. 3B is a schematic diagram of an imaging device in which an optical filter is disposed in an imaging unit.

FIG. 4A is a schematic diagram of a window component using an EC element according to an embodiment of the present disclosure.

FIG. 4B is a schematic sectional view of a window component using an EC element according to an embodiment of the present disclosure, taken in the thickness direction.

FIG. 5 is a plot of the optical density changes ΔOD₅₅₀ of separators against their ionic resistances R.

FIG. 6 is a plot of the optical density changes ΔOD₅₅₀ of separators against their tortuosities τ.

### DESCRIPTION OF THE EMBODIMENTS

The electrochromic (EC) element of the present disclosure includes a pair of electrochromic layers separated by a separator that divides the gap between electrodes into two sections. The EC element according to present disclosure, which is a complementary EC element in which one of the EC layers contains at least a cathodic electrochromic compound, and the other contains at least an anodic electrochromic compound, is designed to achieve low power consumption by specifying the ionic resistance of the separator to exhibit a coloration memory effect. Also, in the present disclosure, the average fiber diameter of the separator is limited to a specific range to achieve excellent transparency.

Exemplary embodiments of the EC element according to the present disclosure will be described in detail with reference to the drawings. The configuration, relative positions, and the like described in the following embodiments are not intended to limit the scope of the present disclosure unless otherwise described.

### EC Element

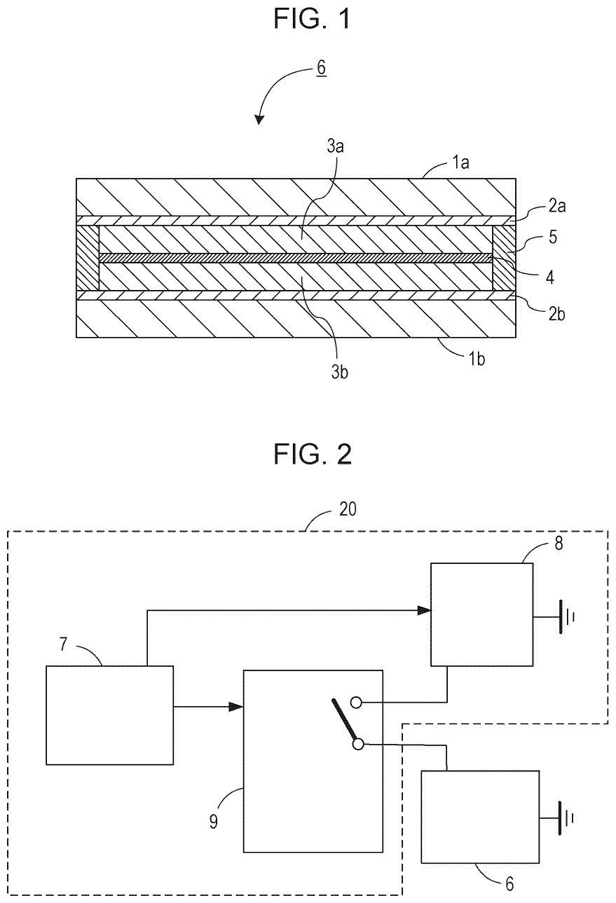

The configuration of the EC element according to present disclosure will first be described with reference to FIG. 1. FIG. 1 is a schematic sectional view of an EC element 6 according to an embodiment of the present disclosure taken in the thickness direction. In FIG. 1, reference numerals 1a and 1b denote a pair of substrates. A pair of electrodes 2a and 2b are each disposed on one surface (on the inner side of the element) of the respective substrates la and 1b. Additionally, EC layers 3a and 3b are provided in contact with the electrodes 2a and 2b, respectively. The EC layers 3a and 3b are separated by a separator 4. Also, a seal 5 is provided at the periphery of the element so as to surround the EC layers 3a and 3b. In the following description, the substrate la is referred to as the first substrate; the substrate 1b as the second substrate; the electrode 2a as the first electrode; the electrode 2b as the second electrode; the EC layer 3a as the first EC layer; and the EC layer 3b as the second EC layer, for convenience.

The members or components of the EC element according to the present disclosure will now be described in detail.

The pair of substrates 1a and 1b, which are transparent, are made of an electrical insulator, such as glass or resin, and are required to be highly transparent, heat-resistant, and chemically stable. Examples of the glass include optical glass, quartz glass, white glass, soda-lime glass, borosilicate glass, non-alkali glass, and chemically reinforced glass. In particular, non-alkali glass is preferably used from the viewpoint of transparency and durability. Examples of the resin include polycarbonate (PC), polymethyl methacrylate (PMMA), polyethylene terephthalate (PET), and transparent polyimide. Such a resin substrate may be provided preferably with a hard coating layer on its surface to enhance scratch resistance.

The pair of electrodes 2a and 2b are made of a transparent electrically conductive material, such as indium tin oxide (ITO), fluorine-doped tin oxide (FTO), tin oxide (NESA), indium zinc oxide (IZO), and graphene. Conductive polymers whose electrical conductivity is increased by doping or the like may also be used preferably, and examples include polyaniline, polypyrrole, polythiophene, polyacetylene, poly(para-phenylene), and complexes of polyethylenedioxythiophene (PEDOT) and poly(styrenesulfonic acid).

The pair of EC layers 3a and 3b separated by the separator 4 are preferably in the form of a solution or gel containing an EC compound dissolved in an organic solvent and may also contain an electrolyte. The EC layers may have spacers to fix the distances between the first electrode 2a and the separator 4 and between the second electrode 2b and the separator 4. The spacers may be made of an inorganic material such as silica beads or glass fibers, or an organic material such as polydivinylbenzene, polyimide, polytetrafluoroethylene, fluorocarbon rubber, or epoxy resin.

The EC layers 3a and 3b may be formed by introducing a liquid containing EC compounds prepared in advance into the gaps between the pair of electrodes 2a and 2b and the separator 4, using vacuum injection, atmospheric injection, a meniscus technique, or the like. Alternatively, the liquid containing EC compounds may be dropped by an ODF (One Drip Fill) method, followed by vacuum bonding the electrodes together with the separator 4, or may be applied onto the pair of electrodes 2a and 2b by blade coating, bar coating, slit die coating, or the like, followed by bonding the electrodes together with the separator 4.

The EC compounds are preferably organic substances. The first EC layer 3a contains at least one cathodic electrochromic compound that is changed from a transparent state to a colored state by a reduction reaction, and the second EC layer 3b contains at least one anodic electrochromic compound that is changed from a transparent state to a colored state by an oxidation reaction. EC elements using both an anodic EC compound and a cathodic EC compound are referred to as complementary EC elements. Anodic EC compounds are also referred to as anodic materials, and cathodic EC compounds are also referred to as cathodic materials.

When a complementary EC element operates, an oxidation reaction occurs at one electrode to draw electrons from the EC compound, and at the other electrode, a reduction reaction occurs to give electrons to the EC compound. The oxidation reaction may produce radical cations from neutral molecules. The reduction reaction may produce radical anions from neutral molecules or produce radical cations from dicationic molecules. In the present disclosure, the EC compounds are colored at both the pair of electrodes 2a and 2b. Consequently, when the EC compounds are colored, a large change in optical density is produced.

Examples of organic EC compounds include electrically conductive polymers, such as polythiophene and polyaniline, and low-molecular-weight organic compounds, such as viologen-based compounds, anthraquinone-based compounds, oligothiophene derivatives, and phenazine derivatives.

In the present disclosure, the first EC layer 3a may contain at least one anodic EC compound, and the second EC layer 3b may contain at least one cathodic EC compound. The EC layers 3a and 3b may have the same composition containing at least one anodic EC compound and at least one cathodic EC compound.

If the EC layers 3a and 3b contain a plurality of EC compounds, the difference in redox potential between or among the EC compounds is preferably small. Such EC layers containing a plurality of EC compounds may contain four or more, or five or more, EC compounds in total in combination of anodic and cathodic compounds. When a plurality of EC compounds are contained, the redox potential of the plurality of anodic materials is preferably within 60 mV, and the redox potential of the plurality of cathodic materials is preferably within 60 mV. When a plurality of EC compounds are contained, the plurality of EC compounds may include a compound having an absorption peak at a wavelength of 400 nm to 500 nm, a compound having an absorption peak at a wavelength of 500 nm to 650 nm, and a compound having an absorption peak at a wavelength of 650 nm or more. An absorption peak is defined as a peak having a half width of 20 nm or more. When absorbing light, the material may be in an oxidized state, a reduced state, or a neutral state.

The electrolyte that may be contained in the EC layers 3a and 3b is an ionically dissociable salt, and, in addition, the electrolyte exhibits high solubility in solvent or, when it is solid, exhibits high compatibility with solvent and is otherwise not limited. In particular, electron-donating electrolytes are preferred. Such electrolytes can be referred to as supporting electrolytes. Examples of the electrolyte include inorganic salts, such as alkali metal salts and alkaline-earth metal salts, quaternary ammonium salts, and cyclic quaternary ammonium salts. More specifically, examples include alkali metal (Li, Na, or K) salts, such as LiClO₄, LiSCN, LiBF₄, LiAsF₆, LiCF₃SO₃, LiPF₆, LiI, NaI, NaSCN, NaClO₄, NaBF₄, NaAsF₆, KSCN, and KCl; and quaternary ammonium salts or cyclic quaternary ammonium salts, such as (CH₃)₄NBF₄, (C₂H₅)₄NBF₄, (n-C₄H₉)₄NBF₄, (n-C₄H₉)₄NPF₆, (C₂H₅)₄NBr, (C₂H₅)₄NClO₄, and (n-C₄H₉)₄NClO₄.

The solvent to dissolve the EC compounds and electrolyte is not limited, provided that it can dissolve the EC compounds and electrolyte, but preferably, it is a polar solvent. Specifically, examples of the solvent include water and organic polar solvents, such as methanol, ethanol, propylene carbonate, ethylene carbonate, dimethyl sulfoxide, dimethoxyethane, γ-butyrolactone, γ-valerolactone, sulfolane, dimethylformamide, tetrahydrofuran, acetonitrile, propionitrile, 3-methoxypropionitrile, benzonitrile, dimethylacetamide, methylpyrrolidinone, and dioxolane.

The EC layers 3a and 3b may further contain a polymer matrix, a gelling agent, and a crosslinking agent. In this instance, the EC layers 3a and 3b may be changed into a gel (physical gel) from a highly viscous liquid by adding a polymer alone or gelled (into a chemical gel) by adding a crosslinking agent to a polymer matrix. Examples of the polymer matrix include polyacrylonitrile, carboxymethyl cellulose, pullulan-based polymer, polyvinyl chloride, polyethylene oxide, polypropylene oxide, polyurethane, polyacrylate, polymethacrylate, polyamide, polyacrylamide, polyester, poly (vinylpyridine), and nafion (registered trademark).

The seal 5 is preferably made of a chemically stable material that is not permeable to gas or liquid and does not interfere with the redox reaction of the EC compounds. For example, the seal 5 may be made of an organic material such as glass frit or an organic material such as epoxy resin.

The separator 4 is preferably made of nanofibers. Nanocellulose (cellulose nanofibers, hereinafter also abbreviated to “CNF”), particularly with a fiber diameter of 10 nm or less, is preferably used to ensure transparency to visible light. Specifically, the light transparency at a wavelength of 550 nm is preferably 80% or more.

The requirements for the separator of the EC element according to present disclosure that achieves low power consumption will now be described in detail.

The separator 4, which is a permselective film that does not allow the EC compounds to pass through but allows electrolytes, prevents contact between the cathodic EC compounds in excitation in the first EC layer 3a and the anodic EC compounds in excitation in the second EC layer 3b to inhibit their cross-reaction (side reaction). Consequently, the power consumption of the EC element 6 is reduced.

The separator 4 can be specified by various physical properties and is preferably specified by physical parameters directly related to its porous structure, such as ionic resistance and tortuosity. The ionic resistance R can be estimated by measuring the impedance in the thickness direction of the separator 4 impregnated with an electrolyte solution. The tortuosity τ can be defined as the ratio of the effective path length to the thickness of the separator 4 by the following equation (1):

$$τ = 1 / d = {( ( R \cdot ε ) / ( ρ \cdot d ) )}^{1 / 2} \qquad ( 1 )$$

where
l: Effective path length (m) in the thickness direction of the separator 4
d: Thickness (m) of the separator 4
R: Ionic resistance (Ωcm²)
ε: Porosity
ρ: Resistivity (Ωm) of the electrolyte solution

While the separator 4 inhibits the cross-reaction between the excited anodic EC compounds and the excited cathodic EC compounds, the resistance of the separator 4 restricts the electrode reaction between the electrodes 2a and 2b. In the present disclosure, when the ionic resistance R of the separator 4 in the thickness direction R is 50 Ωcm² to 300 Ωcm², the electrode reaction between the electrodes 2a and 2b is dominant over the cross-reaction between the excited anodic EC compounds and the excited cathodic EC compounds, thus producing a coloration memory effect of efficiently maintaining the colored state. In view of the responsivity of the EC element 6, the ionic resistance R is preferably 50 Ωcm² to 150 Ωcm². The electrolyte solution used to measure the ionic resistance R is 0.1 M tetrabutylammonium-bis(trifluoromethanesulfonyl)imide/propylene carbonate solution. Bis(trifluoromethanesulfonyl)imide is also abbreviated hereinafter to TFSI.

For the same reason as ionic resistance R, the tortuosity τ of the separator 4 is preferably 1.5 to 4.5. In view of the responsivity of the EC element 6, the tortuosity τ is preferably 1.5 to 3.0.

### Applications of EC Element

The EC element according to present disclosure can be used in optical filters, lens units, imaging devices, window components, and other applications.

### Optical Filter

An optical filter according to an embodiment includes the EC element according to present disclosure and an active element connected to the EC element. The active element drives the EC element and adjusts the amount of light passing through the EC element. The active element may be a transistor, for example. The transistor may contain a semiconductor material, such as InGaZnO, in the active region.

The optical filter of the present embodiment has a drive unit connected to the EC element according to present disclosure. FIG. 2 is a schematic diagram illustrating a drive unit 20 for an EC element and an EC element 6 driven by the drive unit 20. The drive unit 20 of the optical filter of the present embodiment includes a driving power supply 8, a resistor switch 9, and a controller 7.

The driving power supply 8 applies a voltage (driving voltage) required for the electrochemical reaction of the EC materials in the EC layers to the EC element. Preferably, the driving voltage is constant. The reason for the application of a constant voltage is that when a plurality of EC materials are used, the absorption spectrum may vary due to the differences in redox potential and molar absorption coefficient between or among the EC materials. The voltage application from the driving power supply 8 is started or maintained in response to a signal from the controller 7. While the optical transmittance of the EC element 6 is controlled, the application of a constant voltage is maintained.

The controller 7 controls the transmittance of the EC element 6 in a suitable way for the EC element 6. More specifically, predetermined conditions may be input to the EC element 6 according to a desired transmittance set value, or conditions to meet the transmittance set value may be selected and input according to the comparison between the transmittance set value and the transmittance of the EC element 6. Parameters to be varied include voltage, current, and duty ratio. The controller 7 can vary the voltage, current, or duty ratio to change the color density of the EC element 6.

In the embodiments disclosed herein, known techniques can be used to vary voltage and current and modulate the pulse width. Also, the pulse width may be modulated as described below.

The resistor switch 9 switches between a resistor R1 and a resistor R2 with higher resistance than R1 (both not shown) and connects either resistor in series in a closed circuit including the driving power supply 8 and the EC element 6. The resistance of the resistor R1 may be lower than at least the highest impedance in the closed circuit of the element and is, preferably, 10Ω or less. The resistance of the resistor R2 may be higher than the highest impedance in the closed circuit of the element and is, preferably, 1 MΩ or more. The resistor R2 may be air. In this instance, the closed circuit is open in the strict sense but can be considered closed, provided that air is interpreted as resistor R2.

The controller 7 transmits signals to the resistor switch 9 to control the switching between the resistors R1 and R2. Alternatively, the controller 7 may generate PWM signals using a comparator or the like without a resistor switch 9.

### Lens Unit

A lens unit according to an embodiment of the present disclosure includes an imaging optical system including a plurality of lenses, and an optical filter including the EC element according to present disclosure. The optical filter may be disposed between the plurality of lenses or outside the lenses. Preferably, the optical filter is disposed on the optical axis of the lenses.

### Imaging Device

An imaging device according to an embodiment of the present disclosure includes an optical filter and a light-receiving element capable of receiving light passing through the optical filter. Specific examples of the imaging device include cameras, video cameras, and camera phones. The imaging device may be such that the main body including the light-receiving element is separable from a lens unit including one or more lenses. In an embodiment in which the main body of the imaging device is separable from a lens unit, an optical filter apart from the imaging device may be used for imaging. Such a structure is also within the scope of the present disclosure. In such an embodiment, the optical filter may be disposed outside the lens unit, between the lens unit and the light-receiving element, or between the lenses (when the lens unit includes a plurality of lenses).

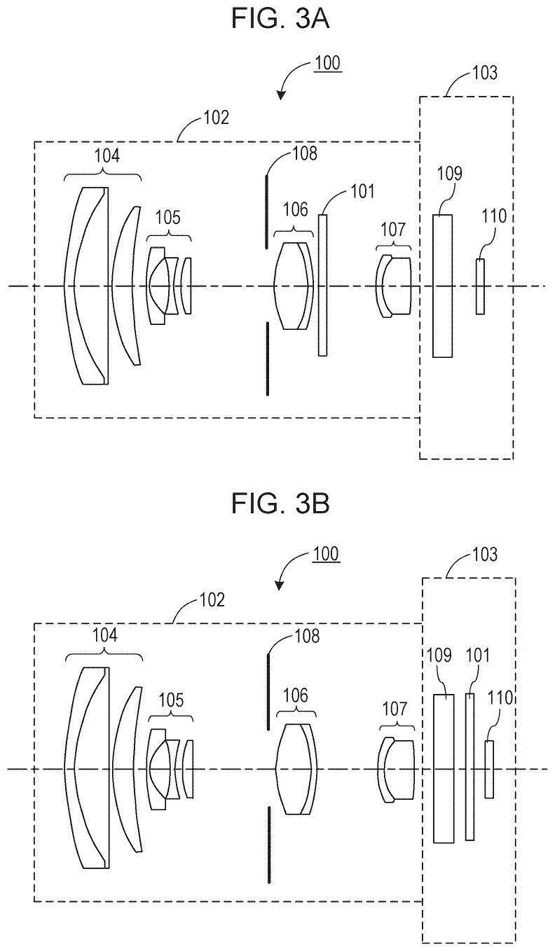

FIG. 3A is a schematic diagram of an example of the imaging device in which the optical filter is disposed in the lens unit, and FIG. 3B is a schematic diagram of an example of the imaging device in which the optical filter is disposed in an imaging unit.

The imaging device 100 includes a lens unit 102 and an imaging unit 103. The lens unit 102 illustrated in FIG. 3A includes an optical filter 101, and an imaging optical system including a plurality of lenses or lens sets. The optical filter 101 includes the EC element according to present disclosure, as in an embodiment described above.

The lens unit 102, for example, in FIG. 3A, is a rear-focusing zoom lens that focuses behind the diaphragm. The lens unit 102 includes four lens sets arranged in the following order from the object to be imaged: a first lens set 104 having a positive refractive power, a second lens set 105 having a negative refractive power, a third lens set 106 having a positive refractive power, and a fourth lens set 107 having positive refractive power. The distance between the second lens set 105 and the third lens set 106 is varied to vary magnification, and some of the lenses of the fourth lens set 107 are moved for focusing.

For example, the lens unit 102 includes an aperture diaphragm 108 between the second lens set 105 and the third lens set 106, and the optical filter 101 between the third lens set 106 and the fourth lens set 107. The lens unit is arranged so that the light entering the lens unit passes through the lens sets 104 to 107, the diaphragm 108, and the optical filter 101 to allow the aperture diaphragm 108 and the optical filter 101 to adjust the amount of light. The lens unit 102 is removably connected to the imaging unit 103 with a mounting member (not shown).

Although in the present embodiment, the optical filter 101 is disposed between the third lens set 106 and the fourth lens set 107 in the lens unit 102, the imaging device 100 is not limited to this configuration. For example, the optical filter 101 may be disposed in front of the aperture diaphragm 108 (on the imaging subject side), behind the aperture diaphragm (on the imaging unit 103 side), in front of or behind any of the first to fourth lens sets 104 to 107, or between any two of the lens sets. Placing the optical filter 101 at the position where light converges is beneficial, for example, for reducing the area of the optical filter 101.

The configuration of the lens unit 102 is also not limited to that described above and may be selected as appropriate. The lens unit may be of a type other than the rear focusing type and may be, for example, of an inner focusing type that focuses on a position in front of the diaphragm or any other type. Also, the lens unit may be a special lens selected as appropriate, such as a fisheye lens or a microlens, as well as a zoom lens.

The imaging unit 103 includes a glass block 109 and a light-receiving element 110. The glass block 109 may be a low-pass filter, a face plate, or a color filter. The light-receiving element 110 is a sensor that receives light passing through the lens unit and may be an imaging element, such as CCD or CMOS. Alternatively, the light-receiving element may be a light sensor such as a photodiode, and an element or device capable of obtaining and outputting information such as light intensity or wavelength may be used as appropriate.

When the optical filter 101 is incorporated in the lens unit 102, as depicted in FIG. 3A, the drive unit may be disposed within or outside the lens unit 102. When disposed outside the lens unit 102, the drive unit is connected to the EC element in the lens unit 102 with a wire for drive control.

In the above-described imaging device 100, the optical filter 101 is located inside the lens unit 102. However, the configuration in the present disclosure is not limited to that of the above embodiment, provided that the optical filter 101 is located at an appropriate position inside the imaging device 100 so that the light-receiving element 110 can receive the light passing through the optical filter 101.

For example, the imaging unit 103 may have the optical filter 101, as depicted in FIG. 3B. FIG. 3B is a schematic diagram of another embodiment of the imaging device according to present disclosure, illustrating a configuration in which the optical filter is located in the imaging unit 103. In FIG. 3B, the optical filter 101 is located, for example, directly in front of the light-receiving element 110. In a configuration in which the imaging device itself incorporates an optical filter 101, the lens unit 102 to be connected need not include the optical filter 101. Accordingly, a dimmable imaging device can be configured using an existing lens unit 102.

The imaging device 100 according to present disclosure can be applied to products including a combination of a light-receiving element and the function of adjusting the amount of light. For example, the imaging device 100 may be a camera, a digital camera, a video camera, and a digital video camera and can also be used in products with built-in imaging devices, such as mobile phones, smartphones, PCs, and tablet computers.

According to the imaging device 100 according to present disclosure, the optical filter 101 can be used as a dimmer member to enable a single filter to vary the dimming level as appropriate. This is beneficial for reducing the number of components and saving space.

### Window Component

A window component according to an embodiment of the present disclosure includes the EC element according to present disclosure and an active element connected to the EC element. The active element drives the EC element and adjusts the amount of light passing through the EC element. The active element may be a transistor, for example. The transistor may contain a semiconductor material, such as InGaZnO, in the active region. The window component according to the present embodiment may be called a variable transmittance window.

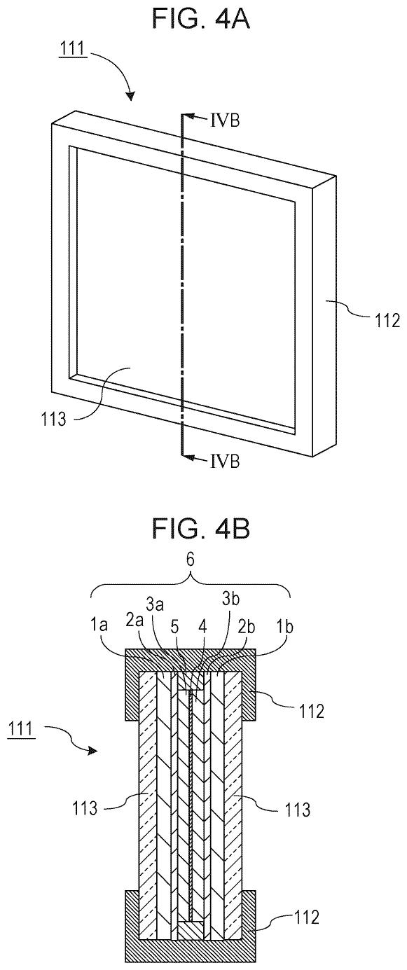

FIG. 4A is a schematic diagram of a dimming window used as a window component including the EC element according to present disclosure, and FIG. 4B is a schematic sectional view taken along line IVB-IVB at the center of FIG. 4A. The dimming window 111 of the illustrated embodiment includes an EC element (optical filter) 6, transparent plates 113 holding the EC element therebetween, and a frame 112 surrounding and integrating the entire structure. The EC element 6 has the structure depicted in FIG. 1 and is provided with a drive unit (not shown). The drive unit may be integrated with the frame 112 or located outside the frame 112 and connected to the EC element 6 with a wire.

The material of the transparent plates 113 is not limited, provided that the material has high light transmittance, and glass is preferably used in view of its use in the window component. The frame 112 may be made of any material, and substantially any structure that covers at least a portion of the EC element 6 and has an integrated form can be considered the frame. While in the embodiment illustrated in FIGS. 4A and 4B, the EC element 6 is a component independent of the transparent plates 113, the substrates la and 1b of the EC element 6, for example, may be considered the transparent plates 113.

The dimming window may be used, for example, to adjust the amount of sunlight entering a room during the daytime. The dimming window may also be used to adjust the amount of heat as well as the amount of sunlight, thus used to control the brightness and temperature in a room. Also, the dimming window may be used as a shutter to block views from the outside to the interior. Such a dimming window may be used as a window for vehicles, such as cars, trains, airplanes, and ships, as well as a glass window for buildings.

Thus, the EC element according to present disclosure can be used in optical filters, lens units, imaging devices, window components, and other applications.

The EC element may be provided with a reflection member in one of the light paths to function as an electrochromic mirror. The EC mirror may be designed as an anti-glare mirror for vehicles. The EC mirror may include an EC element and a reflection member disposed inside or outside the EC element.

Having a reflection member inside the EC element implies that the EC element has a reflective electrode.

Having a reflection member outside the EC element implies that the reflection member is disposed in contact with an electrode of the EC element or with another transparent member between the reflection member and the electrode.

### EXAMPLES

Table 1 presents the physical properties of the separators used in the following Examples. The thickness of the separators is 20 μm, and their light transmittances are the values at a wavelength of 550 nm. Table 1 indicates that separators Nos. 2 to 5 with an average fiber diameter of 10 nm or less are highly transparent, and that these separators have differences in ionic resistance and tortuosity even though their average fiber diameters are the same.

TABLE 1

| | No. 1 | No. 2 | No. 3 | No. 4 | No. 5 |
|---|---|---|---|---|---|
| Average fiber diameter | 3200 | 3.8 | 3.8 | 3.8 | 3.8 |
| (nm) | | | | | |
| Ionic resistance (Ωcm²) | 24.4 | 58.8 | 123.0 | 395.7 | 855.0 |
| Tortuosity τ | 1.21 | 1.92 | 2.46 | 5.29 | 6.16 |
| Light transmittance (%) | 0.3 | 89.2 | 89.4 | 89.6 | 88.1 |

### Example 1

An EC element was fabricated by ODF and vacuum bonding using separator No. 2 presented in Table 1 and ITO glass substrates with a sheet resistance of 10 Ω/sq. The thicknesses of the pair of EC layers were fixed by mixing gap-controlling particles of 40 μm in diameter. Each EC layer contained the anodic and cathodic EC compounds presented below and propylene carbonate (solvent) and was in a chemical gel in which polyvinylpyridine polymer was crosslinked. The pair of EC layers had the same composition. The dimming region of the EC element was defined in 20 mm×20 mm, and an epoxy resin seal surrounded the periphery.

### Anodic EC Compounds

MOPOPhO1MedMdHPhzn: 3-(2-isopropoxy-6-methoxyphenyl)-1,5,10-trimethyl-8-phenoxy-5,10-dihydrophenazine
mMeOPhO1MediPrdHPhzn: 5,10-diisopropyl-2-(3-methoxyphenoxy)-7-methyl-5,10-dihydrophenazine

### Cathodic EC Compounds

F3BuAFlu2TFSI: 9,9-dimethyl-2,7-bis (4,4,4-trifluorobutyl)-9H-cyclopenta [1,2-c:4,3-c′]dipyridinium bis[bis(trifluoromethanesulfonyl)imide]
pdtBuPh3MeVTFSI: 1,1′-bis(4-tert-butyl)phenyl-3-methyl-4,4′-dipyridinium bis[bis(trifluoromethanesulfonyl)imide]

These four EC compounds were added to the EC layers at the following concentrations.
MOPOPhO1MedMdHPhzn: 27 mM
mMeOPhO1MediPrdHPhzn: 351 mM
F3BuAFlu2TFSI: 284 mM
pdtBuPh3MeVTFSI: 94 mM

When a constant voltage of 0.55 V was applied to the resulting EC element, the light transmittance at a wavelength of 550 nm decreased from 76.2% to 1.0% in 153 seconds. The voltage was further applied for another 180 seconds, and when the light transmittance reached 0.70%, the circuit was opened. After one hour, the light transmittance was 1.34% (optical density change ΔOD₅₅₀=−0.28), and the colored state was maintained (indicating a coloration memory effect).

### Example 2

An EC element was fabricated in the same manner as in Example 1, except that separator No. 3 presented in Table 1 was used. When a constant voltage of 0.55 V was applied to the resulting EC element, the light transmittance at a wavelength of 550 nm decreased from 80.4% to 1.0% in 166 seconds. The voltage was further applied for another 180 seconds, and when the light transmittance reached 0.81%, the circuit was opened. After one hour, the light transmittance was 1.21% (optical density change ΔOD₅₅₀=−0.17), and the colored state was maintained (indicating a coloration memory effect).

### Comparative Example 1

An EC element was fabricated in the same manner as in Example 1, except that separator No. 1 presented in Table 1 was used. When a constant voltage of 0.55 V was applied to the resulting EC element, the current became substantially constant in about 60 seconds, and the light transmittance at a wavelength of 550 nm decreased from 18.2% to 5.4%. The voltage was further applied for another 180 seconds, and when the light transmittance reached 4.6%, the circuit was opened. The light transmittance was returned to its initial value in about 90 seconds (optical density change ΔOD₅₅₀=−0.60, indicating no memory effect).

Separator No. 1, which had a large average fiber diameter of 3.2 μm, scattered visible light and impaired the transparency as an EC element, and, in addition, its ionic resistance R was too low to exhibit a coloration memory effect. Consequently, a large amount of power was required to maintain the colored state.

### Comparative Examples 2, 3, and 4

An EC element of Comparative Example 2 was fabricated in the same manner as in Example 1, except that no separator was used. Also, EC elements of Comparative Examples 3 and 4 were fabricated in the same manner as in Example 1, except that separators Nos. 4 and 5 presented in Table 1 were used, respectively.

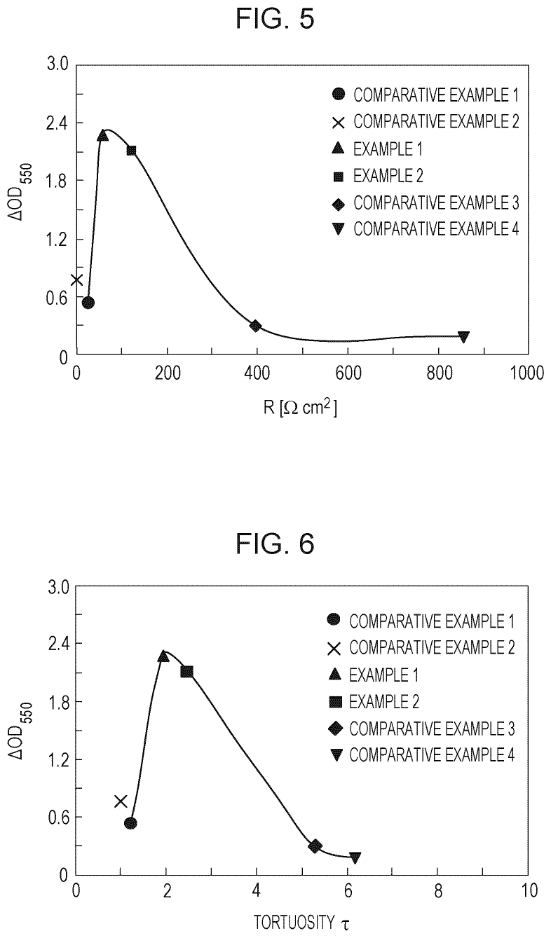

FIG. 5 plots optical density changes ΔOD₅₅₀ at a wavelength of 550 nm of the EC elements of Examples 1 and 2 and Comparative Examples 1 to 4 when a constant voltage of 0.55 V was applied for 3 minutes against the ionic resistance R of the separator. As the ionic resistance R of the separator increases, the current of the element decreases. Despite this fact, however, the optical density change ΔOD₅₅₀ of the EC elements of Examples 1 and 2 is larger than that of Comparative Examples 1 and 2. This indicates that the electrode reaction in the EC elements of the Examples is dominant over the charge exchange reaction (side reaction) and suggests that these elements efficiently maintain their colored state. In the EC elements of Comparative Examples 3 and 4, the electrode reaction is restricted due to their large ionic resistance R. This is probably the reason for the small optical density changes ΔOD₅₅₀. Accordingly, the ionic resistance R of the separator in the thickness direction should be 50 Ωcm² to 300 Ωcm².

FIG. 6 plots optical density changes ΔOD₅₅₀ at a wavelength of 550 nm of the EC elements of Examples 1 and 2 and Comparative Examples 1 to 4 when a constant voltage of 0.55 V was applied for 3 minutes against the tortuosity τ of the separator. The plot suggests that the tortuosity τ of the separator is preferably 1.5 to 4.5.

Table 2 presents the optical density changes ΔOD₅₅₀ at a wavelength of 550 nm of the EC elements of Examples 1 and 2 and Comparative Examples 1 to 4 when a constant voltage of 0.55 V was applied for 3 minutes, and the presence or absence of a coloration memory effect in the EC elements. The relative values in the field for the optical density change ΔOD₅₅₀ are those relative to the optical density change ΔOD₅₅₀ of Comparative Example 2, which is set as 1.0. The coloration memory effect was estimated by applying a constant voltage of 0.55 V to each EC element for 3 minutes and then opening the circuit. When the absolute value of the optical density change ΔOD₅₅₀ (increase in transmittance) after one hour was less than 0.3, the EC element was considered to have a coloration memory effect, and when it was 0.3 or more, the EC element was considered to have no memory effect.

TABLE 2

| | Example | Example | Comparative | Comparative | Comparative | Comparative |
|---|---|---|---|---|---|---|
| | 1 | 2 | Example 1 | Example 2 | Example 3 | Example 4 |
| Separator No. | No. 2 | No. 3 | No. 1 | — | No. 4 | No. 5 |
| ΔOD₅₅₀ | 2.27 | 2.11 | 0.54 | 0.77 | 0.30 | 0.19 |
| (Relative value) | (2.9) | (2.7) | (0.7) | (1.0) | (0.4) | (0.2) |
| Coloration memory | Yes | Yes | No | No | Yes | Yes |
| effect | | | | | | |

The present disclosure can provide an EC element that has a coloration memory effect, resulting in low power consumption, and that is excellent in transparency in its neutral state, which is achieved by limiting the average fiber diameter of the separator.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrochromic element comprising:
a first electrode;
a second electrode;
a separator that divides a gap between the first electrode and the second electrode into two sections;
a first electrochromic layer disposed between the first electrode and the separator and containing at least one cathodic electrochromic compound; and
a second electrochromic layer disposed between the second electrode and the separator and containing at least one anodic electrochromic compound, wherein the separator has an ionic resistance of 50 Ωcm² to 300 Ωcm² in the thickness direction thereof when impregnated with 0.1 M tetrabutylammonium bis(trifluoromethanesulfonyl)imide/propylene carbonate solution.

2. The electrochromic element according to claim 1, wherein the separator is made of nanofibers.

3. The electrochromic element according to claim 2, wherein the separator has an average fiber diameter of 10 nm or less.

4. The electrochromic element according to claim 2, wherein the nanofibers are made of nanocellulose.

5. The electrochromic element according to claim 1, wherein the separator has a tortuosity of 1.5 to 4.5.

6. The electrochromic element according to claim 1, wherein the separator has a light transmittance of 80% or more at a wavelength of 550 nm.

7. An optical filter comprising:
the electrochromic element according to claim 1; and
a transistor connected to the electrochromic element.

8. A lens unit comprising:
the optical filter according to claim 7; and
an imaging optical system including a plurality of lenses.

9. An imaging device comprising:
the optical filter according to claim 7; and
a light-receiving element configured to receive light passing through the optical filter.

10. A window component comprising:
the electrochromic element according to claim 1; and
a transistor connected to the electrochromic element.

11. An electrochromic mirror comprising:
the electrochromic element according to claim 1; and
a reflection member disposed inside or outside the electrochromic element.
